(19) United States
(12) Patent Application Publication
(10) Pub. No.: US 2013/0190453 A1
(43) Pub. Date: Jul. 25, 2013

(54) TWO COMPONENT RESIN SYSTEM

(71) Applicants: Arie Boer Den, Kampen (NL); Johan Franz Gradus Antonius Jansen, Geleen (NL); Daniel Raimann, Baretswil (CH); Erik Reuther, Mannheim (DE); Silvana Rensina Antonnietta Silvestre Di, Berg aan de Maas (NL)

(72) Inventors: Arie Boer Den, Kampen (NL); Johan Franz Gradus Antonius Jansen, Geleen (NL); Daniel Raimann, Baretswil (CH); Erik Reuther, Mannheim (DE); Silvana Rensina Antonnietta Silvestre Di, Berg aan de Maas (NL)

(21) Appl. No.: 13/576,815

(22) PCT Filed: Feb. 11, 2011
(86) PCT No.: PCT/EP2011/052037

§ 371 Date: Jan. 11, 2013

(30) Foreign Application Priority Data
Feb. 11, 2010 (EP) 10153329.7

(51) Int. Cl. C08L 63/00

(52) U.S. Cl. CPC C08L 63/00
USPC 525/118; 252/182.23

(57) ABSTRACT

Two component resin system consisting of a first component A and a second component B characterized in that component A comprises: a. a compound capable of undergoing a radical copolymerization selected from the group consisting of unsaturated polyester resins, vinyl ester resins and mixtures thereof, b. an epoxide functional resin as compound capable of reacting with an aliphatic amine and in that component B comprises a mixture of c. an aliphatic amine d. a perester.

The present invention relates to a two component resin system consisting of a first component A and a second component B, one component comprises a resin and the other component comprises the hardener for the resin.

Two component resin systems are used for many constructions, maintenance, repair and assembly applications. The two component resin systems are used for packing a resin and a hardener which upon mixing form an adhesive. Traditionally, epoxy adhesives or methacrylate adhesives have been sold with the resin and the hardener packaged in separate compartments, so that the resin and the hardener do not react before the product is to be used.

These two component resin systems traditionally are used for forming one polymer network such as for example vinyl ester resin networks based on polyfunctional methacrylate compounds dissolved in a reactive diluent and which are cured by free radical initiated copolymerization or epoxy-amine networks which are commonly cured by step growth copolymerization.

The object of the invention is to provide a two component resin system that can be applied for forming a hybrid cured resin network. As used herein, two component resin systems means that the different compounds of the system are present in two spatially separated components in order to prevent premature polymerization of the compounds prior to the use of the two component resin system to obtain the hybrid cured resin network. Hybrid curing refers to curing effected by at least two different reaction mechanisms.

Such two component resin system is used for obtaining an Interpenetrating Polymer Network (IPN). As used herein, an Interpenetrating Polymer Network is a composition of at least two chemically distinct polymer networks that are at least partially interlaced on a molecular scale and that are optionally covalently bonded to each other. Besides true IPNs in which no covalent binding exists between the polymer networks, also semi IPNs can be formed. In a semi IPN, the two networks are covalently linked via a linking component which can react with the amine as well as can undergo a radical polymerisation. In case that covalent binding is present between the polymer networks, the IPN is referred to as a semi IPN. In an IPN each network may retain its individual properties. As a result an improvement in properties can be attained as in an IPN the individual properties of at least two networks are combined.

In the article “Curing behaviour of IPNs formed from model VERs and epoxy systems I amine cured epoxy”, K. Dean, W. D. Cook, M. D. Zipper, P. Burchill, Polymer 42 (2001), 1345-1359, it is described that one polymer network is formed by radical polymerization of vinyl ester resin (compound containing methacrylate) dissolved in styrene with a radical initiator such as a peroxide. The other polymer network is formed by step growth copolymerization of an epoxy compound with an amine. The primary amine initially reacts with the epoxy group followed by the reaction of the secondary amine. The IPN is formed by mixing the vinyl ester resin and the epoxy compound separately with the respective radical initiator and curing agents before being combined to give a miscible blend.

Thus the essential elements for forming such an IPN as described in the article are a methacrylate containing compound, radical initiator such as a peroxide, an epoxy compound and an amine. Mixtures of amines with peroxides however are known to be unstable as they react with each other (E. T. Denisov, R. G. Denisova, T. S. Denisova, Handbook of free radical initiators, 2003). For instance a well known initiation system is based on the decomposition of benzoyl peroxide with teriary aromatic amines and used in many polymerizations (G. Odian, Principles of polymerization, 3^{rd} edition p. 220 (1991)). The reaction of benzoyl peroxide with other amines like butylamine or triethylamine is also very fast (and can even react explosively) (P. D. Bartlett, K. Nozaki, J. Am. Chem. Soc. v 69, p 2299 (1947)). The vigorous reaction of hydroperoxides, like for instance reaction of hydrogen peroxide with amines above 0° C., has also been described. (G. L. Matheson, O. Maass, J. Am. Chem. Soc. v 51, p 674 (1929)).

In addition, in view of the fact that a methacrylate is reactive towards a peroxide (free radical initiated polymerization) as well as to an amine (Michael addition) and an epoxy compound is reactive towards an amine, mixing of these compounds may only take place at the time the IPN or semi IPN is intended to be formed. In a semi IPN, the two networks are covalently linked via a linking component which can react with the amine as well as can undergo a radical copolymerisation Therefore, at least three components are needed to store the methacrylate compound, the peroxide, the epoxy compound and the amine. One possible way to store these compounds is a three component system consisting of one component containing the epoxy compound and the peroxide, another component containing the amine and still another component containing the methacrylate compound. The other possible way to store the compounds is a three component system consisting of one component containing the epoxy compound and the methacrylate compound, another component containing the amine and still another component containing the peroxide.

However in view of handling a two component resin system is desired.

The object of the present invention is to provide a two component resin system that can be applied for storing the compounds used for forming a hybrid cured resin system containing a radical curable resin/peroxide curing system and an epoxy/amine curing system. For such a two component resin (2K) system, it is essential that the mixture of the amine with the peroxide is a stable mixture.

This object is achieved in that the first component A of the two component system comprises (a) a compound capable of undergoing a radical copolymerization selected from the group consisting of unsaturated polyester resins, vinyl ester resins and mixtures thereof, (b) an epoxide functional resin as compound capable of reacting with an aliphatic amine, and the second component B comprises a mixture of (c) an aliphatic amine and (d) a perester.

Surprisingly the inventors have now found that a mixture of an aliphatic amine with a perester is stable at room temperature thereby enabling such 2 K systems.

In the present invention, a mixture of an aliphatic amine (compound (c)) and a perester (compound (d)) that is stable at room temperature refers to a mixture of an aliphatic amine and a perester which is still able to cure compound (a) at room temperature, preferably which is still able to cure a mixture of compound (a) and compound (b) at room temperature, after having stored the mixture of compound (c) and compound (d) for 24 hours at room temperature. The mixture is considered to be able to cure in case adding the mixture to at least compound (a) results in a gel time (measured according to DIN 16945).

As used herein, a vinyl ester resin is a (meth)acrylate containing compound, i.e. a compound comprising at least one reactive (meth)acrylate group. Preferably, the resin system comprises an unsaturated polyester resin or a vinyl ester resin as compound (a) capable of undergoing radical copolymerization. More preferably, the resin system comprises a vinyl ester resin as compound (a) capable of undergoing radical copolymerization. Even more preferably, the compound (a) capable of undergoing radical copolymerization is a vinyl ester resin.

The unsaturated polyester resin or vinyl ester resin used in the context of the present invention may be any such resin as is known to the person skilled in the art. Examples thereof can be found in a review article of M. Malik et al. in J.M.S.—Rev. Macromol. Chem. Phys., C40 (2&3), p. 139-165 (2000). The authors describe a classification of such resins—on the basis of their structure—in five groups:
(1) Ortho-resins: these are based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A.
(2) Iso-resins: these are prepared from isophthalic acid, maleic anhydride or fumaric acid, and glycols.
(3) Bisphenol-A-fumarates: these are based on ethoxylated bisphenol-A and fumaric acid.
(4) Chlorendics: are resins prepared from chlorine/bromine containing anhydrides or phenols.
(5) Vinyl ester resins: these are resins, which are mostly used because of their hydrolytic resistance and excellent mechanical properties. They have unsaturated sites only in the terminal position, for example introduced by reaction of epoxy resins (e.g. diglycidyl ether of bisphenol-A, epoxies of the phenol-novolac type, or epoxies based on tetrabromobisphenol-A) with (meth)acrylic acid. Instead of (meth)acrylic acid also (meth)acrylamide may be used.

Besides the vinyl ester resins as described in Malik et al., also the class of vinyl ester urethane resins (also referred to urethane (meth)acylate resins) are herein considered to be vinyl ester resins. A preferred vinyl ester resin is an oligomer or polymer containing at least one (meth)acrylate functional end group, also known as (meth)acrylate functional resins. This also includes the class of vinyl ester urethane resins. Preferred vinyl ester resins are methacrylate functional resins including urethane methacrylate resins. Preferred methacrylate functional resins are resins obtained by reaction of an epoxy oligomer or polymer with methacrylic acid or methacrylamide, preferably with methacrylic acid.

The compound (a) capable of undergoing radical copolymerization preferably has a number-average molecular weight Mₙ of at least 200 Dalton, more preferably of at least 300 Dalton and even more preferably of at least 500 Dalton. The compound capable of undergoing radical copolymerization preferably has a number-average molecular weight Mₙ of at most 10.000 Dalton and more preferably at most 5000 Dalton. As used herein, the number-average molecular weight (Mₙ) is determined in tetrahydrofuran using GPC employing polystyrene standards.

The compound (a) capable of undergoing radical copolymerization preferably has an acid value as low as possible in order to prevent salt formation of the radical polymerisable compound with the amine. The compound capable of undergoing radical copolymerization preferably has an acid value of at most 60 mg KOH/g (determined according to ISO 2114-2000), more preferably of at most 40 mg KOH/g, even more preferably of most 5 mg KOH/g and even more preferably 0 mg KOH/g. In view of this, a vinyl ester resin is preferably applied as compound (a) capable of undergoing radical copolymerization.

The compound (b) capable of reacting with an aliphatic amine is an epoxide functional resin, i.e. a resin containing at least one epoxy group. Preferably, the resin system according to the invention comprises a bisepoxide (containing two epoxide groups) as epoxide functional resin. In a preferred embodiment, the epoxide functional resin is a bisepoxide.

Preferably, the epoxide functional resin comprises a glycidylether as epoxide functionality. In a preferred embodiment, the resin system according to the invention comprises a glycidylether as epoxide functional resin. In a more preferred embodiment, the epoxide functional resin is a glycidylether.

The compound (b) capable of reacting with an aliphatic amine preferably has a number-average molecular weight Mₙ of at least 300 Dalton, more preferably of at least 500 Dalton and even more preferably of at least 750 Dalton. The compound capable of reacting with an aliphatic amine preferably has a number-average molecular weight Mₙ of at most 10.000 Dalton and more preferably of at most 5000 Dalton.

In a preferred embodiment, component A preferably comprises a compound capable of undergoing radical copolymerization with a molecular weight of at least 300 Dalton and further comprises a reactive diluent. The diluent, for instance, will be applied for adjustment of the viscosity of the resin system in order to make handling thereof more easy. Moreover, adjustment of cross-linking in the cured products may be achieved if the diluent contains groups that are reactive with the reactive moieties in the resin. In such case, the diluent is called a reactive diluent. A reactive diluent may contain all kinds of such reactive groups, but the groups may also be identical to reactive moieties in the resin.

Preferably, at least part of the reactive diluent is capable of a radical copolymerization. Examples of suitable monomers are, for instance, alkenyl aromatic monomer, such as for example styrene and divinylbenzene, (meth)acrylates, vinyl ethers and vinyl amides but all other reactive monomers for use in the field of thermosetting resins as are known to the person skilled in the art can be used. Preferred monomers are styrene, alpha-methyl styrene, chlorostyrene, vinyl toluene, divinyl benzene, methyl methacrylate, tert.butyl styrene, tert.butylacrylate, butanediol dimethacrylate and mixtures thereof. Suitable examples of (meth)acrylates reactive diluents are PEG200 di(meth)acrylate, 1,4-butanediol di(meth)acrylate, 1,3-butanediol di(meth)acrylate, 2,3-butanedioldi(meth)acrylate, 1,6-hexanediol di(meth)acrylate and its isomers, diethyleneglycol di(meth)acrylate, triethyleneglycol di(meth)acrylate, glycerol di(meth)acrylate, trimethylolpropane di(meth)acrylate, neopentyl glycol di(meth)acrylate, dipropyleneglycol di(meth)acrylate, tripropyleneglycol di(meth)acrylate, PPG250 di(meth)acrylate, tricyclodecane dimethylol di(meth)acrylate, 1,10-decanediol di(meth)acrylate, tetraethylene glycol di(meth)acrylate and trimethylolpropanetri(meth)acrylate. It should be remarked that in some cases methacrylates may have the function of compound capable of undergoing radical copolymerisation as well as the function of reactive diluent.

Preferably, at least part of the reactive diluent is capable of reacting with an aliphatic amine. More preferably, at least part of the reactive diluent is capable of both reacting with an aliphatic amine as well as being capable of radical copolymerization in which case a semi IPN will be formed.

Component A preferably further comprises a transition metal salt or complex. The presence of such transition metal compound is beneficial as it accelerates the decomposition of the peroxide and therefore accelerates the radical polymerisation. Preferably, component A comprises a salt or complex of transition metal with an atomic number in the range from 22 to 29 or with an atomic number in the range from 38 to 49 or with an atomic number in the range from 57 to 79. More preferably, the transition metal salt or complex is a salt or complex of Mn, Fe, Cu, V and Co, even more preferably selected from Mn, Fe and Cu. Even more preferably, the transition metal salt or complex is a salt or complex of Mn and Cu as the low temperature performance of the hybrid cured resin network can be further improved. The Mn, Fe, Cu, V or Co compound is preferably a Mn, Fe, Cu, V or Co carboxylate, more preferably a Mn, Fe, Cu, V or Co C₁- C₃₀ carboxylate and even more preferably a Mn, Fe, Cu, V or Co C₁-C₁₆ carboxylate.

A skilled person will be able to determine a suitable amount of transition metal compound. The amount of transition metal compound present in the resin system according to the invention is preferably such that at least 0.0001 mmol transition metal per kg of curable compounds is present, more preferably at least 0.0025 mmol transition metal per kg of curable compounds and even more preferably at least 0.025 mmol transition metal per kg of curable compounds. The upper limit of transition metal content is not very critical, although for reasons of cost efficiency of course no extremely high concentrations will be applied. Generally the concentration of transition metal in the resin system will be lower than 50 mmol transition metal per kg of curable compounds, preferably lower than 20 mmol transition metal per kg of curable compounds.

Preferably, at least one of the components A and B further comprises an inhibitor in order to further improve the storage stability of the two component resin system according to the invention. More preferably, component A comprises an inhibitor. Preferably, the inhibitor is selected from the group of stable radicals, phenolic inhibitors, hydroquinones, catechols, phenothiazines and mixtures thereof.

Suitable examples of inhibitors that can be used in the present invention are, for instance, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, napthoquinone, 1-oxyl-2,2,6,6-tetramethylpiperidine, 1-oxyl-2,2,6,6-tetramethylpiperidine-4-ol (a compound also referred to as TEMPOL), 1-oxyl-2,2,6,6-tetramethylpiperidine-4-one (a compound also referred to as TEMPON), 1-oxyl-2,2,6,6-tetramethyl-4-carboxyl-piperidine (a compound also referred to as 4-carboxy-TEMPO), 1-oxyl-2,2,5,5-tetramethylpyrrolidine, 1-oxyl-2,2,5,5-tetramethyl-3-carboxylpyrrolidine (also called 3-carboxy-PROXYL), aluminium-N-nitrosophenyl hydroxylamine, diethylhydroxylamine, phenothiazine and/or derivatives or combinations of any of these compounds.

Component B preferably comprises a primary and/or secondary aliphatic amine as compound (c). The amine in component B is preferably a primary and/or secondary aliphatic amine. Preferably, component B comprises at least a primary aliphatic amine as compound (c). Examples of suitable aliphatic amines are: 1,2-diaminoethane; 1,2-diaminopropane; 1,3-diaminopropane; 1,4-diaminobutane; as well as 2-methyl-1,5-diaminopentane; 1,3-diaminopentane; 2,2,4-trimethyl-1,6-diaminohexane; 2,4,4-trimethyl-1,6-diaminohexane; 1-amino-3-aminomethyl-3,5,5-trimethylcyclohexane; 2,2-dimethyl-1,1,3-diaminopropane; 1,3-bis(aminomethyl)cyclohexane; 1,2-diaminocyclohexane and 1,3-bis(aminomethyl)benzene.

The perester present in component B is preferably an aromatic perester. The required amount of perester can be easily determined by a person skilled in the art and the amount can be varied within wide ranges, in general higher than 0.0001 wt. % and less than 20 wt. %, preferably less than 10 wt. % and more preferably less than 5 wt. % (wherein the amount of perester is relative to the total amount of curable compounds).

The molar ratio of radical polymerizable functionalities and the funtionalities capable of reacting with the aliphatic amine in the resin system according to the invention is preferably from 10:1 to 1: 10, more preferably from 5:1 to 1:5 and even more preferably from 3:1 to 1:3. As used herein, for all upper and/or lower boundaries of any range given, the boundary value is included in the range.

The molar ratio of epoxide functionalities and amine —NH— functionalities in the resin system according to the invention is preferably from 5:1 to 1:5, more preferably from 3:1 to 1:3, even more preferably from 2:1 to 1:2, even more preferably from 1.5:1 to 1:1.5 and most preferably 1:1. For clarity, a primary amine has two NH functionalities and a secondary amine has one NH functionality.

In the resin system according to the invention also fillers can be present. These fillers can be present in any of the components of the 2K system. Therefore, according to another embodiment of the invention at least one of the components A or B further comprises one or more fillers and/or fibres. A wide variety of fillers can be applied like for instance, without being limited thereto, silica, sand, cement, pigments. A wide variety of fibres can be applied like for instance, without being limited thereto, glass and carbon fibres.

The present invention also relates to a process for curing the two component resin system according to the invention by mixing both components. The curing is preferably effected at a temperature in the range of from −20 to +200° C., preferably in the range of from −20 to +100° C., and most preferably in the range of from −10 to +60° C. (so-called cold curing).

The present invention relates to two component thermosetting resin systems. Thermosetting resins are generally used to produce a composite material for obtaining a structural object. The present invention further also relates to cured objects, in particular structural objects, as are being obtained when curing the resin system according to the invention by mixing component A and component B. As meant herein, structural objects are considered to have a thickness of at least 0.5 mm and appropriate (depending on the ultimate application of the structural object) mechanical properties.

The present invention further relates to the use of the cured objects in anyone of the areas of automotive parts, boats, chemical anchoring, roofing, construction, containers, relining, pipes, tanks, flooring or windmill blades.

The present invention further relates to a composition comprising a mixture of an aliphatic amine and a perester. Surprisingly the inventors have found that a mixture of an aliphatic amine with a perester is stable at room temperature. The aliphatic amine is preferably a primary and/or secondary aliphatic amine. The perester is preferably an aromatic perester.

The present invention further relates to a multicomponent resin system comprising (a) a compound capable of undergoing a radical copolymerization selected from the group consisting of unsaturated polyester resins, vinyl ester resins and mixtures thereof, (b) an epoxide functional resin as compound capable of reacting with an aliphatic amine, (c) an aliphatic amine and (d) a perester, whereby both the aliphatic amine and the perester are present in one of the components of the multicomponent resin system. Preferred compounds and amounts are as described above. The use of the multicomponent resin system according to the invention requires mixing of the compounds (a), (b), (c) and (d) to obtain a hybrid cured resin network. As used herein, multicomponent resin systems means that the different compounds of the system are present in at least two spatially separated components in order to prevent premature polymerization of the compounds prior to the use of the multicomponent resin system to obtain the hybrid cured resin network. The multicomponent resin system according to the invention comprises at least two components. In one embodiment, the multicomponent resin system is a three component system consisting of three components A, B and C, wherein component A consists of a resin composition comprising compound (a) as described above; component B consists of a composition comprising a mixture of an aliphatic amine (c) and a perester (d), and component C consists of a resin composition comprising compound (b) as described above. The perester is preferably an aromatic perester. The aliphatic amine is preferably a primary and/or secondary aliphatic amine.

The invention is now demonstrated by means of a series of examples and comparative examples. All examples are supportive of the scope of claims. The invention, however, is not restricted to the specific embodiments as shown in the examples.

### Monitoring of Curing

Curing was monitored by means of standard gel time equipment. This is intended to mean that both the gel time (T_{gel} or T_{25→35° C.}) and peak time (Tₚₑₐₖ or T_{25→peak}) were determined by exotherm measurements according to the method of DIN 16945. The equipment used therefore was a Soform gel timer, with a Peakpro software package and National Instruments hardware; the waterbath and thermostat used were respectively Haake W26, and Haake DL30.

### Mechanical Property Determination

For the determination of mechanical properties 4 mm castings were prepared.

Mechanical properties of the cured objects were determined according to ISO 527-2. The Heat Distortion Temperature (HDT) was measured according to ISO 75-A.

### EXAMPLE 1 AND COMPARATIVE EXPERIMENTS

Screening of peroxide amine mixtures.

0.05 g of peroxide was added very carefully to 0.5 g of amine. Visually was determined if an immediate reaction has been taken place. Of the mixtures which were visually stable, a DSC measurement was performed after 8 hrs. Via this method an estimation of the remaining reaction enthalphy was made and consequently it was determined whether the amine peroxide mixture had reacted partially in this short time period. The results are shown in table 1.

TABLE 1

| exp | Peroxide (type) | amine | Result |
|---|---|---|---|
| 1.1 | Trigonox C | 1,2-diaminopropane | Stable |
| | (perester) | | |
| 1.2 | | 1,5-diamino-2 | Stable |
| | | methylpentane | |
| 1.3 | | Dibutylamine | Stable |
| 1.4 | | Tributylamine | Stable |
| A | | Aniline | DSC pre reaction |
| B | | n-ethyl aniline | DSC pre reaction |
| C | | dimethylaniline | DSC pre reaction |
| D | Perkadox 26 | 1,2-diaminopropane | Explosive reaction |
| | (percarbonate) | | |
| E | | Dibutylamine | Explosive reaction |
| F | | Tributylamine | Explosive reaction |
| G | | Aniline | Immediate reaction |
| H | | n-ethyl aniline | Immediate reaction |
| I | | Di methylaniline | Explosive reaction |
| J | Perkadox CH-50L | 1,2-diaminopropane | Explosive reaction |
| | (peranhydride) | | |
| K | | Dibutylamine | Immediate reaction |
| L | | Tributylamine | Immediate reaction |
| M | | Aniline | Immediate reaction |
| O | | n-ethyl aniline | Immediate reaction |
| N | | Di methylaniline | Explosive reaction |
| P | Trigonox AW70 | 1,2-diaminopropane | DSC Pre reaction |
| | (hydroperoxide) | | |
| Q | | Dibutylamine | DSC Pre reaction |
| R | | Tributylamine | Immediate reaction |
| S | | Aniline | DSC Pre reaction |
| T | | n-ethyl aniline | Immediate reaction |
| V | | Di methylaniline | Immediate reaction |
| X | Butanox M50 | 1,2-diaminopropane | DSC Pre reaction |
| | (perketal) | | |
| Y | | Dibutylamine | DSC Pre reaction |
| Z | | Tributylamine | DSC Pre reaction |
| Aa | | Aniline | DSC Pre reaction |
| Ab | | n-ethyl aniline | DSC Pre reaction |
| Ac | | Di methylaniline | DSC Pre reaction |
| Ad | Trigonox 44B | 1,2-diaminopropane | DSC Pre reaction |
| | (perketal) | | |
| Ae | | Dibutylamine | DSC Pre reaction |
| Af | | Tributylamine | DSC Pre reaction |
| Ag | | Aniline | DSC Pre reaction |
| Ah | | n-ethyl aniline | DSC Pre reaction |
| Ai | | Di methylaniline | Immediate reaction |

Stable means no prereaction noticed upon DSC.

These examples 1.1-1.4 combined with the comparative experiments clearly demonstrate that only the combination according to the invention leads to stable peroxide amine mixtures.

### EXAMPLE 2

A resin formulation was prepared by mixing 100 g bisphenol A diglycidyl ether, 66.5g butanediol dimethacrylate and 0.8 g Cu naphtenate in spririts (8 wt % Cu).

An amine peroxide mixture was prepared by mixing 31 g 1,5-diamino-2 methylpentane and 4g t-butylperbenzoate.

After storing for 24 hr the reactivity of the system was determined in the geltimer using 25 g of the resin formulation and 3.5 g of the peroxide mixture resulting in a geltime of 12.3 min a peak time of 34.5 min and a peak temperature of 172° C.

A 1 mm casting was prepared using 50 g of resin and 7 g of peroxide mixture. The resulting cured casting has Tg of 46° C.

### EXAMPLE 3

A resin formulation was prepared as A component by mixing 193 g bisphenol A glycerolate dimethacrylate, 128 g butanediol dimethacrylate, 514 g bisphenol A diglycidyl ether, 161 g glycidylmethacrylate, 4 g Cu naphtenale in spirits (8 wt % Cu), 0.005 g Tempol and 0.002 g hydroquinone.

An amine peroxide mixture was prepared as the B component by mixing 124 g 1,5-diamino-2 methylpentane and 16 g t-butylperbenzoate.

The reactivity of the system was determined in the gel timer using 25 g of A component and 3.5 g of B component resulting in a gel time of 10.8 min, a peak time of 18.6 min and a peak temperature of 206° C.

After storing both the A and B components at room temperature for 23 weeks, the curing was repeated resulting in a gel time of 12.9 min, a peak time of 20.8 min and a peak temperature of 205° C.

This result clearly demonstrates that the peroxide amine combination according to the invention is stable at room temperature for a prolonged period of time. Furthermore this example demonstrates that such a combination can be used for initiation a free-radical polymerization combined with a condensation reaction with an amine resulting in a cured composite resin.

### EXAMPLE 4

An A component was prepared by mixing 500g Daron XP-45 (vinyl ester resin in styrene), 500 g Epon 828 (diepoxy resin) and 2 g Cu naftenate solution (8 wt % Cu in spirits). A B component was prepared by mixing 16 g Trigonox C (a perester) with 86 g Dytek A (1,5-diamino-2-methylpentane; an aliphatic diamine). After storing both mixtures for 24 hrs the B component was added to the A component and a 4 mm casting was prepared. After standing at room temperature for 16 hrs the casting was released from the mould and post cured during 16 hrs at 80° C. followed by 5 hrs at 100° C.

The mechanical properties of the so obtained cured resin were Tg 125° C., HDT 102° C., Tensile strength 86 MPa, Tensile modulus 3.5 GPa, elongation at break 5%, Flexural strength 139 MPa, Flexural modulus 3.6 GPa.

This result indicates that using the stable peroxide amine combination according to the invention cured objects were obtained having good mechanical properties.

### EXAMPLE 5

A resin formulation was prepared by mixing 60 g bisphenol A diglycidyl ether, 40 g butanediol dimethacrylate and ×g transition metal solution (5 mmol/ kg resin mixture).

An amine peroxide mixture was prepared by mixing 102 g 1,5-diamino-2 methylpentane and 12 g t-butylperbenzoate.

After storing for 24 hr the reactivity of the system was determined in the geltimer using the resin formulation and mixing that with 14 g of the amine peroxide mixture. The results are shown in table 2.

TABLE 2

| | | | | Gel | Peak | peak |
|---|---|---|---|---|---|---|
| | | | | time | time | temperature |
| Ex | metal | g | type | (min) | (min) | (° C.) |
| 5.1 | Co | 2.34 | NL49P | 3.75 | 50 | 120 |
| 5.2 | Co | 0.36 | Rockwood Co8 | 7.76 | 28.27 | 174 |
| 5.3 | Fe | 0.23 | Nuodex Fe12 | 2 | 5.5 | 202 |
| 5.4 | Cu | 0.38 | Nuodex Cu8 | 25 | 67 | 169 |
| 5.5 | Mn | 0.27 | Nuodex Mn10 | 2 | 8.5 | 180 |
| 5.6 | Mn | 0.45 | Mn ethylhexanoate 6 | 3.2 | 10.5 | 202 |
| | | | wt % | | | |
| 5.7 | V | 0.12 | Vanadium tripropoxide | 99 | 163 | 81 |

These examples clearly demonstrate that various transition metals can be used with the peroxide amine combination according to the invention.

### EXAMPLE 6

A resin formulation was prepared by mixing 600 g bisphenol A diglycidyl ether, 400 g butanediol dimethacrylate and 2.7 g Nuodex Mn10. This formulation was divided into 100g portions to which various amounts of various inhibitors were added.

An amine peroxide mixture was prepared by mixing 102 g 1,5-diamino-2 methylpentane and 12 g t-butylperbenzoate.

After storing for 24 hr the reactivity of the system was determined in the geltimer using the resin formulations containing inhibitor and mixing that with 14 g of the amine peroxide mixture. The results are shown in table 3.

TABLE 3

| | | | | | peak |
|---|---|---|---|---|---|
| | | | Gel time | Peak time | temperature |
| Ex | inhibitor | amount | (min) | (min) | (° C.) |
| 6.1 | Tempol | 500 | 13.1 | 23.3 | 191 |
| 6.2 | Hydroquinone | 500 | 10.3 | 22.8 | 187 |
| 6.3 | Catechol | 500 | 7.7 | 15.7 | 176 |

These examples clearly demonstrate that various inhibitors can be used in order to tune the reactivity in combination with the peroxide amine mixture according to the invention.

1. Two component resin system consisting of a first component A and a second component B, characterized in that component A comprises:
a. a compound capable of undergoing a radical copolymerization selected from the group consisting of unsaturated polyester resins, vinyl ester resins and mixtures thereof,
b. an epoxide functional resin as compound capable of reacting with an aliphatic amine
and in that component B comprises a mixture of
c. an aliphatic amine
d. a perester.

2. Two component resin system according to claim 1, characterized in that the compound (a) capable of undergoing radical copolymerization is an unsaturated polyester resin or a vinyl ester resin.

3. Two component resin system according to claim 1, characterized in that the compound (a) capable of undergoing radical copolymerization is a vinyl ester resin.

4. Two component resin system according to claim 1, characterized in that the vinyl ester resin is an oligomer or polymer containing at least one (meth)acrylate functional end group.

5. Two component resin system according to claim 1, characterized in that the epoxide functionalitly is a glycidyl ether.

6. Two component resin system according to claim 1, characterized in that component A further comprises a reactive diluent and that at least part of the reactive diluent is capable of a radical copolymerization.

7. Two component resin system according to claim 6, characterized in that at least part of the reactive diluent is capable of reacting with an aliphatic amine.

8. Two component resin system according to claim 1 characterized in that component B comprises a primary and/or secondary aliphatic amine as compound (c).

9. Two component resin system according to claim 1, characterized in that component B comprises a primary aliphatic amine as compound (c).

10. Two component resin system according to claim 1, characterized in that the perester in component B is an aromatic perester.

11. Two component resin system according to claim 1 characterized in that component A further comprises a transition metal salt or complex.

12. Cured objects obtained by mixing the two components A and B of the two component resin system according to claim 1.

13. Use of the cured objects of claim 12 in anyone of the areas of automotive parts, boats, chemical anchoring, roofing, construction, containers, relining, pipes, tanks, flooring or windmill blades.

14. Composition comprising a mixture of an aliphatic amine and a perester.

15. Composition according to claim 14, characterized in that the aliphatic amine is a primary and/or secondary aliphatic amine.

16. Multicomponent resin system comprising (a) a compound capable of undergoing a radical copolymerization selected from the group consisting of unsaturated polyester resins, vinyl ester resins and mixtures thereof, (b) an epoxide functional resin as compound capable of reacting with an aliphatic amine, (c) an aliphatic amine and (d) a perester, whereby both the aliphatic amine and the perester are present in one of the components of the multicomponent resin system.
